(19) United States
(12) Patent Application Publication
(10) Pub. No.: US 2026/0010823 A1
(43) Pub. Date: Jan. 8, 2026

(54) DYNAMIC MACHINE LEARNING HYPERPARAMETER TUNING FOR FEEDBACK-DRIVEN OPTIMIZATION

(71) Applicant: The Regents of the University of California, Oakland, CA (US)

(72) Inventors: Soheil Zibakhsh-Shabgahi, San Diego, CA (US); Aiden Tabrizi, San Diego, CA (US); Farinaz Koushanfar, San Diego, CA (US)

(21) Appl. No.: 18/765,880

(22) Filed: Jul. 8, 2024

(51) Int. Cl. G06N 20/00

(52) U.S. Cl. CPC G06N 20/00

(57) ABSTRACT

In some implementations, one or more program variables are monitored during training of an untrained version of a machine learning model, where the one or more program variables correspond to one or more hyperparameters associated with the training. A request is detected to update a first program variable while the untrained version of the machine learning model is being trained. In response to detecting the request, a first hyperparameter corresponding to the first program variable is modified without interrupting the training. After the modification, training of the machine learning model continues with the modified first hyperparameter. A trained version of the machine learning model is generated when training of the untrained version of the machine learning mode is completed.

### TECHNICAL FIELD

The present disclosure generally relates to tuning hyperparameters during training of machine learning models.

### BACKGROUND

This decade has seen a surge in feedback-driven optimization, most notably in machine learning paradigms. The increasing need for computational power for fine-tuned optimization in complex systems is pressing, calling for optimized utilization of computing resources. As one of the most prominent methods of feedback-driven optimization, deep learning's rise is attributed to two primary factors: the availability of vast data sets, and advancements in hardware which enhance computational capabilities. This also applies to several other learning paradigms, such as reinforcement learning.

Training state-of-the-art machine learning models requires access to large amounts of data, as well as massive computational resources. For example, recent language models are trained on terabytes of data, have billions of parameters, and require hundreds of graphics processing unit (GPUs) and algorithmic expertise for training. Training contemporary artificial intelligence (AI) models may require investment in procuring learning data and computing resources, making the training expensive in terms of procuring access to the necessary computing resources and the required manpower in terms of expertise and time. Accordingly, there is a need in the art for techniques to reduce the resources, manpower, and time required to train machine learning models.

### SUMMARY

In some implementations, one or more program variables are monitored during training of an untrained version of a machine learning model, where the one or more program variables correspond to one or more hyperparameters associated with the training. A request is detected to update a first program variable while the untrained version of the machine learning model is being trained. In response to detecting the request, a first hyperparameter corresponding to the first program variable is modified without interrupting the training. After the modification, training of the machine learning model continues with the modified first hyperparameter. A trained version of the machine learning model is generated when training of the untrained version of the machine learning mode is completed.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a computing system, in accordance with some example implementations of the current subject matter;

FIG. 2 illustrates an example of a LiveTune framework, in accordance with some example implementations of the current subject matter;

FIG. 3 illustrates a diagram of a LiveTune variable change procedure, in accordance with some example implementations of the current subject matter;

FIG. 4 illustrates an example of a graphical user interface for dynamically adjusting hyperparameters during machine learning training, in accordance with some example implementations of the current subject matter;

FIG. 5 illustrates an example of a graphical user interface for generating a listing of dynamic hyperparameter changes for a given training run, in accordance with some example implementations of the current subject matter;

FIG. 6 illustrates an example of a graphical user interface showing a list of hyperparameters that may be adjusted by the user in manual mode, in accordance with some example implementations of the current subject matter;

FIG. 7 illustrates an example of a user interface for dynamically adjusting the learning rate, in accordance with some example implementations of the current subject matter;

FIG. 8 illustrates an example of a graphical user interface which allows the user to set a threshold for causing a hyperparameter turning engine to switch from manual mode to automatic mode, in accordance with some example implementations of the current subject matter;

FIG. 9 illustrates an example of a heat map of how an agent is moving inside a gridworld, in accordance with some example implementations of the current subject matter;

FIG. 10 illustrates an example of a live plot of fitness of an agent, in accordance with some example implementations of the current subject matter;

FIG. 11 illustrates an example of a process for performing dynamic hyperparameter turning during machine learning model training, in accordance with some example implementations of the current subject matter;

FIG. 12 illustrates an example of a process for a hyperparameter tuning engine transitioning between manual and automatic mode, in accordance with some example implementations of the current subject matter;

FIG. 13 illustrates an example of a process for generating a user interface for enabling a user to control a hyperparameter tuning engine operating mode, in accordance with some example implementations of the current subject matter; and

FIG. 14 illustrates an example of a system, in accordance with some example implementations of the current subject matter.

### DETAILED DESCRIPTION

Recent artificial intelligence (AI) trends involve complex networks with billions of parameters, requiring extended training periods, some of which last months. Training the contemporary sophisticated networks demands a careful selection of hyperparameters. Hyperparameters, distinct from model parameters updated during training, are often static or follow predetermined trajectories. As used herein, the term “hyperparameters” may be defined as a set of numerical parameters that define a machine learning model architecture and that are used to control the training process of the machine learning model. Hyperparameters include structural elements like layer counts and per-layer parameters, as well as algorithmic settings such as learning rate, momentum, regularizations, and batch size. The choice of hyperparameters significantly impacts model performance and training speed. Hence, selecting the right hyperparameters requires expertise and deliberate planning before training begins. In common practice, researchers do extensive tests on a smaller subset of the data to determine the neighborhood of the best-performing hyperparameters. Often, this selection involves a thorough exploration of the hyperparameter space.

Existing methods for hyperparameter tuning, such as grid search and Bayesian optimization, are impractical for machine learning development and rapid testing. In the experimentation phase of machine learning workflows, manual tuning and testing of different combinations of hyperparameters based on feedback, like the loss curve, is key. Manual tuning is a resource-intensive process that involves setting checkpoints, and then loading and remaking those checkpoints after every variable change. This is a repetitive task and often takes multiple attempts before the neighborhood of the right hyperparameter is found, wasting not only time but also exhausting hardware resources on every restart. After the range of correct hyperparameter values is found, an exhaustive search is done to find the best-performing set of hyperparameters.

The repetitive overhead of prominent learning paradigms is further characterized by the intense and iterative optimization workflow of reinforcement learning (RL). In RL, users may incorporate immediate feedback into the training workflow to achieve an optimal policy. In most scenarios, this requires complex algorithms that automate the integration of gathered feedback, or the user is required to stop training and start again with adjusted hyperparameters. In current workflows, users are not able to dynamically adjust RL parameters based on the performance of an agent's current policy, which drastically increases the amount of time and resources needed to find an optimal policy.

Even after sophisticated and resource-intensive algorithms are run to find suitable hyperparameter configurations, a human expert is often required to perform their own manual search to pinpoint the ideal hyperparameters for training. This takes a heavy toll on computing time and overhead, as training is in a constant cycle of starting to observe the effects of the hyperparameters and stopping if the hyperparameters are not suitable. LiveTune, a novel framework allowing real-time hyperparameter adjustment, addresses this issue by allowing users to update hyperparameters without reloading the program instance. This enables a much more time and resource-efficient approach to training large ML models.

Feedback-driven optimization, such as traditional machine learning training, is a static process that lacks real-time adaptability of hyperparameters. Tuning solutions for optimization require trial and error paired with checkpointing and schedulers, in many cases feedback from the algorithm is overlooked. Adjusting hyperparameters during optimization usually requires the program to be restarted, wasting utilization and time, while placing unnecessary strain on memory and processors. In an example, LiveTune enables real-time parameter adjustment of optimization loops through Live Variables. Live Variables allow for continuous feedback-driven optimization by storing parameters on designated ports on the system, allowing them to be dynamically adjusted. Extensive evaluations of the LiveTune framework on standard machine learning training pipelines show saving up to 60 seconds and 5.4 Kilojoules of energy per hyperparameter change. The feasibility and value of LiveTune may be shown in a reinforcement learning application where the users change the dynamics of the reward structure while the agent is learning showing 5× improvement over the baseline. Finally, a fully automated workflow is outlined to provide end-to-end, unsupervised feedback-driven optimization. This approach introduces unprecedented flexibility in optimization workflows, offering a new paradigm in continuous tuning while incorporating feedback. The framework contributes to reductions in execution time and power consumption across optimization paradigms.

Each LiveVariable instance may be initialized with a tag, an initial value, and a designated port on the host machine. Its internal value can be modified through this port. LiveVariables can replace normal variables in any code, such as those representing hyperparameters, allowing developers to update them and see the change immediately, without having to restart the process. Another component of LiveTune is the “LiveTriggers” feature. LiveTriggers are boolean flags that can be embedded in the program code or within loops. Leveraging LiveTune's dynamic variable modification capability, LiveTriggers can activate or halt procedures based on developer commands, without needing to terminate the program. Upon activation, a LiveTrigger returns ‘True’ once before reverting to its default ‘False’ state.

Utilizing LiveTune has demonstrated a notable acceleration in optimization processes. This specification will detail the underlying mechanisms of LiveTune, its applications, and provide empirical evidence supporting its efficacy as a trans-formative tool in feedback-driven optimization. In summary, LiveTune enables real-time, manual hyperparameter tuning in a manner that is energy-efficient and minimally disruptive to the optimization process. LiveTune is versatile such that it is applicable to any optimization pipeline regardless of objective or scale while inducing minimal overhead. Development of “LiveVariables” and “LiveTriggers” enables dynamic variable updates and control over subprocesses without program termination. LiveTune allows users to update hyperparameters without reloading the program instance. This enables a much more time and resource-efficient approach to training large machine learning models. An open source API may be utilized for LiveTune to facilitate automation and adaptation of the method in optimizing real-world systems. Extensive evaluations of LiveTune's open-source API demonstrates significant time and energy savings compared to conventional optimization in emerging learning paradigms.

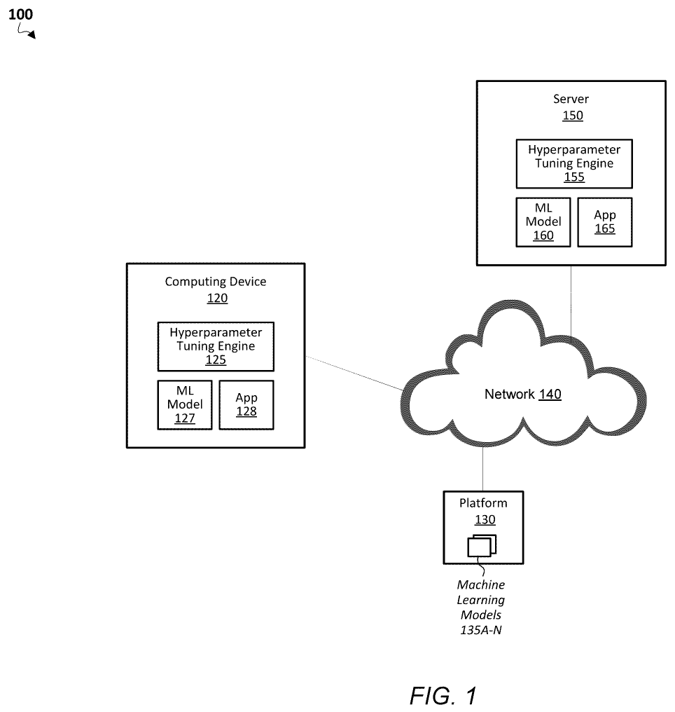

Referring now to FIG. 1, an example of a computing system 100 is depicted, in accordance with some example embodiments. As shown in FIG. 1, the computing system 100 may include at least a server 150, a platform 130, and computing device 120 connected to network 140. Generally speaking, the server 150 and/or platform 130 may provide resources that can be shared among a plurality of tenants (i.e., clients). In various embodiments, the server 150 and/or platform 130 may be configured to provide a variety of services including, for example, software-as-a-service (SaaS), platform-as-a-service (PaaS), infrastructure as a service (IaaS), and/or the like, and these services can be accessed by one or more tenants of the server 150 and/or platform 130.

In an example, platform 130 may offer various machine learning models 135A-N and/or other software applications for use to a variety of customers. The access to machine learning models 135A-N may be subscription based or on usage based for each use of a given machine learning model 135A-N and/or a particular software application. Server 150 may train various machine learning models that are later provided on platform 130 for access by different tenants.

Tuning hyperparameters has proven to be the most important task in machine learning training, as every model architecture and dataset has a unique set of hyperparameter configurations that enable optimal performance. Rather than model parameters, which are learned during training, hyperparameters dictate the learning process and must be iteratively tuned to progressively enable better learning. Some fundamental hyperparameters include learning rate, regularization coefficients, number of epochs, and momentum.

Hyperparameter tuning involves systematically searching for an optimal combination of hyperparameters that results in the best performance of the model. A naive approach to this is a user performing a brute-force search across the entire hyperparameter space. Autonomous methods, such as grid search, allow users to specify a predefined range within the hyperparameter space that they believe will enable high performance. Random search algorithms randomly sample the hyperparameter space and return the hyperparameters that showed the most promise. Search algorithms are often very resource-intensive and do not guarantee suitable results. More advanced methods, such as Bayesian optimization, use probabilistic models to predict how different hyperparameter configurations will perform. These methods are more efficient than search algorithms, however, they still may require fine-tuning by a user to achieve optimal results.

In an example, server 150 includes hyperparameter tuning engine 155 for enabling a user to dynamically adjust hyperparameters during training of a machine learning model (e.g., machine learning model 160), with training managed by application 165. In an example, this user may be associated with computing device 120. More details on how hyperparameter tuning engine 155 enables dynamic tuning of hyperparameters during training will be provided after a brief discussion of the architecture of system 100. In another example, computing device may include hyperparameter tuning engine 125 and application 128 to train machine learning model 127 locally on computing device 120 without interacting with server 150. In a further example, a hybrid approach may be employed, where a portion of the functionality of a hyperparameter tuning engine and/or a corresponding application is implemented locally on computing device 120 and a portion the functionality of the hyperparameter tuning engine and/or the corresponding application is implemented on server 150.

The server 150 and/or platform 130 may include resources, such as at least one computer (e.g., a server), data storage, and a network (including network equipment) that couples the computer(s) and storage. The server 150 and/or platform 130 may also include other resources, such as operating systems, hypervisors, and/or other resources, to virtualize physical resources (e.g., via virtual machines) and provide deployment (e.g., via containers) of applications (which provide services, for example, on the server, and other resources). In the case of a “public” server or cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the server 150 and/or platform 130 may be part of a “private” cloud platform, in which case the server 150 and/or platform 130 may be one of an entity's own private servers (e.g., dedicated corporate servers operated and/or owned by the entity). Alternatively, or additionally, the server 150 and/or platform 130 may be considered part of a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the system 100 includes computing device 120 which is representative of any number of clients (i.e., tenants). For example, multitenancy enables multiple end-user devices (e.g., a computer including an application) to access a given server having shared resources via the Internet and/or other type of network or communication link(s). It is noted that computing device 120 may also be referred to as a computing system, a computing apparatus, and so on. Machine learning models 135A-N and 160 are representative of any type of machine learning models. For example, machine learning models 135A-N may include neural networks, recurrent neural networks, convolutional neural networks, generative models, generative neural networks, generative adversarial networks, generative pre-trained transformers, diffusion models, and so on. Other types of machine learning models are possible and are contemplated.

As shown in FIG. 1, the server 150, the platform 130, and the computing device 120 may be communicatively coupled via a network 140. Network 140 may be any wired and/or wireless network including, for example, a public land mobile network (PLMN), a wide area network (WAN), a local area network (LAN), a virtual local area network (VLAN), the Internet, and/or the like. Computing device 120 may be a processor-based device including, for example, a smartphone, a tablet computer, a wearable apparatus, a virtual assistant, an Internet-of-Things (IoT) appliance, and/or the like.

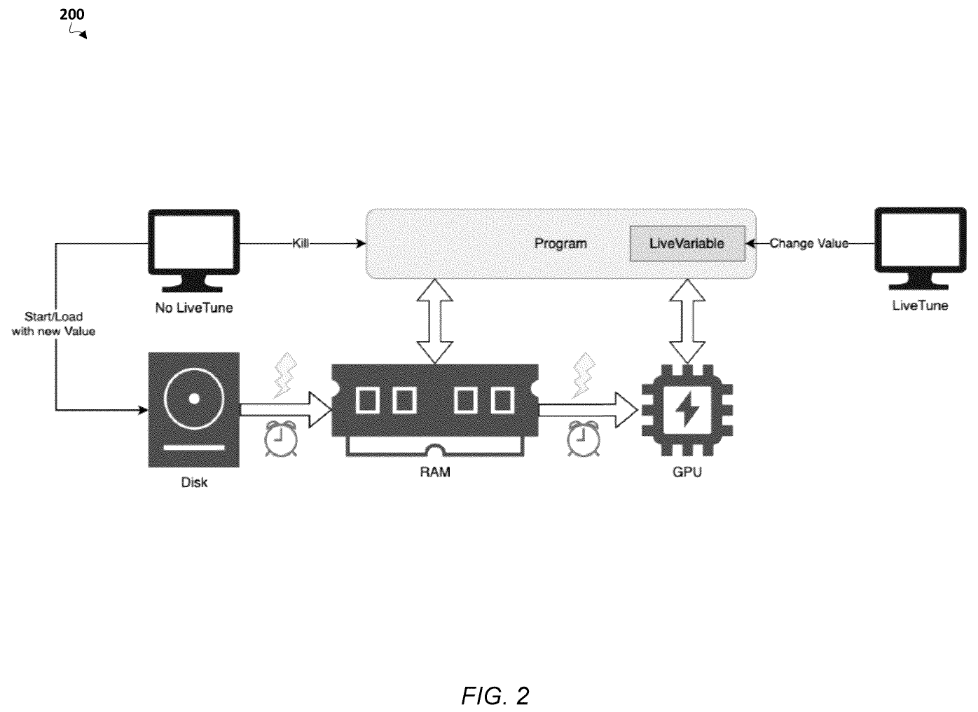

Turning now to FIG. 2, an example of a LiveTune framework 200 is depicted, in accordance with some example embodiments. FIG. 2 depicts the LiveTune framework 200 with an innovative approach to enabling continuous training through Live Variables. Live Variables are a specialized class of variables designed for dynamic adjustments during runtime without restarting the training process. Upon creation, each Live Variable allocates a port on the host machine, replacing static variables, such as learning rates, with a dynamic counterpart. These variables are managed by initiating a dedicated listener thread per instance, which monitors and updates the variable's value safely using TCP and semaphore mechanisms. The internal state of a Live Variable is composed of the current value, a unique tag, and the assigned port, which can be queried through its instance.

Modification of a Live Variable's value during runtime is performed by sending a new value to its listener port via TCP. This is managed safely with semaphores to prevent conflicts. The is_changed( ) method within the Live Variable class is crucial for determining if updates to the variable are necessary, facilitating efficient continuous training. The management of multiple Live Variable ports may be streamlined through a dictionary thread. Employing the singleton pattern, this thread maintains a unique instance that logs each Live Variable's tag and port, ensuring system-wide consistency. Communication with this central dictionary is essential for coordinating updates and maintaining system integrity.

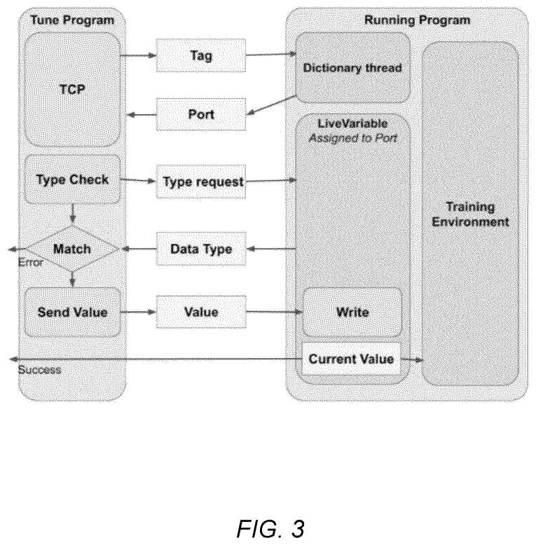

The user interface of the LiveTune system, referred to as the tune program, simplifies the process of variable adjustment. The user interface of the LiveTune system utilizes the dictionary port, a tag, and a new value for the operation, establishing a secure communication link with the dictionary thread to verify and update values as depicted in FIG. 3. This process ensures that adjustments are applied correctly without type mismatches or disruptions to the main program. By integrating these components, the LiveTune framework supports real-time hyperparameter tuning, significantly enhancing the flexibility and efficiency of machine learning training processes.

LiveTune is a versatile framework designed to accommodate a variety of workflows across different domains. It does not prescribe a specific workflow but instead provides tools that enhance interaction with program variables dynamically through Live Variables. By design, Live Variables are engineered to return their most recent values upon being called, making them ideally suited for use within repetitive loop structures.

In typical use cases, each iteration within a loop provides feedback to the user in the form of log files, output data, or visual plots. Based on this feedback, users can make informed decisions about necessary adjustments to the program's variables. Through the provided API, these changes can be implemented instantly, affecting the subsequent iteration. For instance, in a supervised learning scenario, the learning rate could be set as a Live Variable. As the training progresses, the program outputs the current training and test losses at each iteration. Analyzing these loss curves enables the expert to adjust the learning rate dynamically, optimizing the training process in real time.

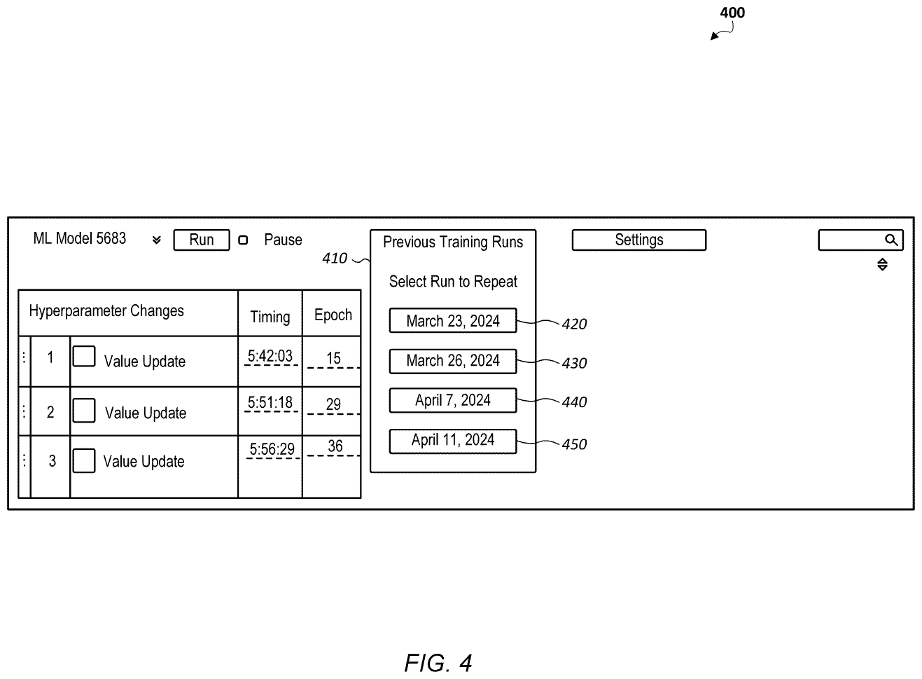

Turning now to FIG. 4, a diagram of a graphical user interface (GUI) for dynamically adjusting hyperparameters during machine learning training is shown, in accordance with some example embodiments. In an example, a programmer or owner of a machine learning model may train the machine learning model using the LiveTune framework. During the training, the programmer may dynamically adjust hyperparameter values utilizing the LiveTune framework. These adjustments that are made to the hyperparameter values may be stored. Also, the timing of when the adjustments are made to the hyperparameter values within the training run may be stored. The timing may refer to the elapsed time from the start of the training run and/or the timing may refer to a specific epoch or a specific pass within a given epoch. Snapshots of these hyperparameter adjustments may be stored together in a file corresponding to a particular machine learning model training run. Storing the hyperparameter adjustments and corresponding timing enables the ability to exactly recreate the training run with the same hyperparameter changes. In other words, if the programmer or another user wanted to repeat the training run using the exact same adjustments to the hyperparameters at exactly the same time as they occurred in the original training run, the stored adjustments may be utilized to repeat the training run. Consequently, storing the hyperparameter adjustments enables reproducibility of machine learning model training runs.

Additionally, multiple snapshot files may be collected of dynamic hyperparameter adjustments that were made for a plurality of machine learning model training runs by one or more experts in real-time. A library of snapshot files may be created for different types of machine learning models that were training with their hyperparameters tuned via LiveTune or via another dynamic hyperparameter adjustment tool. The library may be categorized (i.e., organized) into subsets of snapshot files corresponding to different types of machine learning models. These snapshot files, or a particular category of snapshot files, may then be used to train a separate machine learning model that learns how to make hyperparameter adjustments based on receiving these snapshot files of hyperparameter adjustments as inputs. Once trained, this separate machine learning model, which may be referred to as a hyperparameter tuning machine learning model, may be used to make dynamic hyperparameter adjustments for new machine learning models that are being trained.

In an example, a GUI may include a pull-down menu or other type of graphical element to allow a user to repeat a previous training run. This is illustrated by graphical element 410 in GUI 400 of FIG. 4. Additionally, a GUI may allow a user to select which set of hyperparameter adjustments to use when repeating the previous training run. For example, a plurality of hyperparameter adjustment recordings from previous training runs may be stored, and the GUI may allow the user to select the specific set of hyperparameter adjustments to apply to a new training run. In an example, graphical elements 420, 430, 440, and 450 of the expanded pull-down menu 410 correspond to different sets of hyperparameter adjustments which may be applied to a new training run.

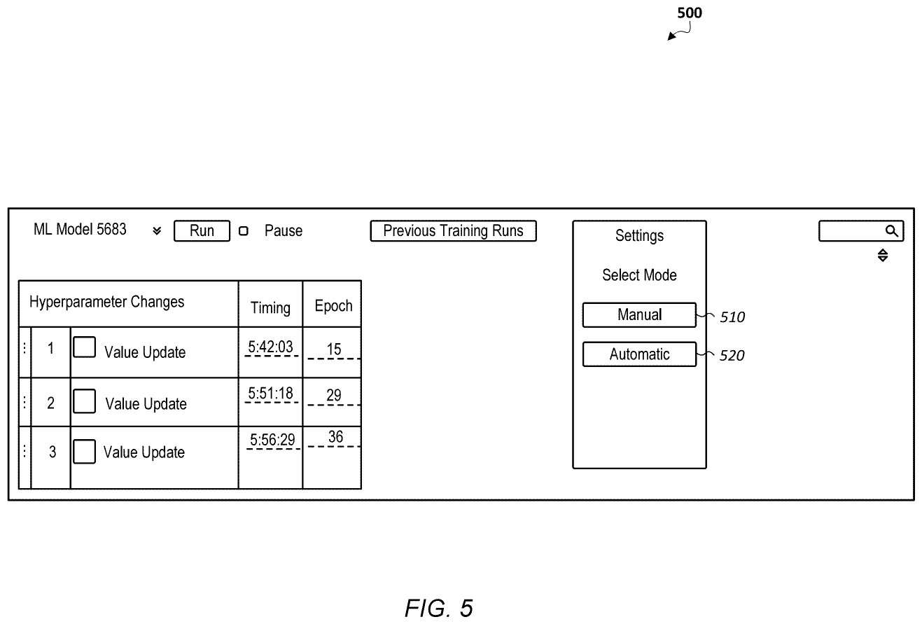

In some cases, a machine learning model may be adjusted or fine-tuned during development. This may involve changing the number of layers, the type of one or more of the individual layers, and so on. After this change to the underlying machine learning model, a new training run may be initiated. Rather than adjusting the hyperparameters dynamically for the new training run, the GUI may present the user with the option of applying a previous set of hyperparameter adjustments to the new training run. Alternatively, the GUI may present the user with the option of manually controlling the hyperparameter values during the new training run. This is illustrated by graphical element 510 of GUI 500 (of FIG. 5), with graphical element 510 allowing the user to select manual mode for manually controlling the hyperparameter adjustments. GUI 500 also include graphical element 520 which allows the user select automatic mode, with automatic mode putting the hyperparameter tuning engine in control of hyperparameter adjustments rather than having the user manually control the hyperparameter adjustments.

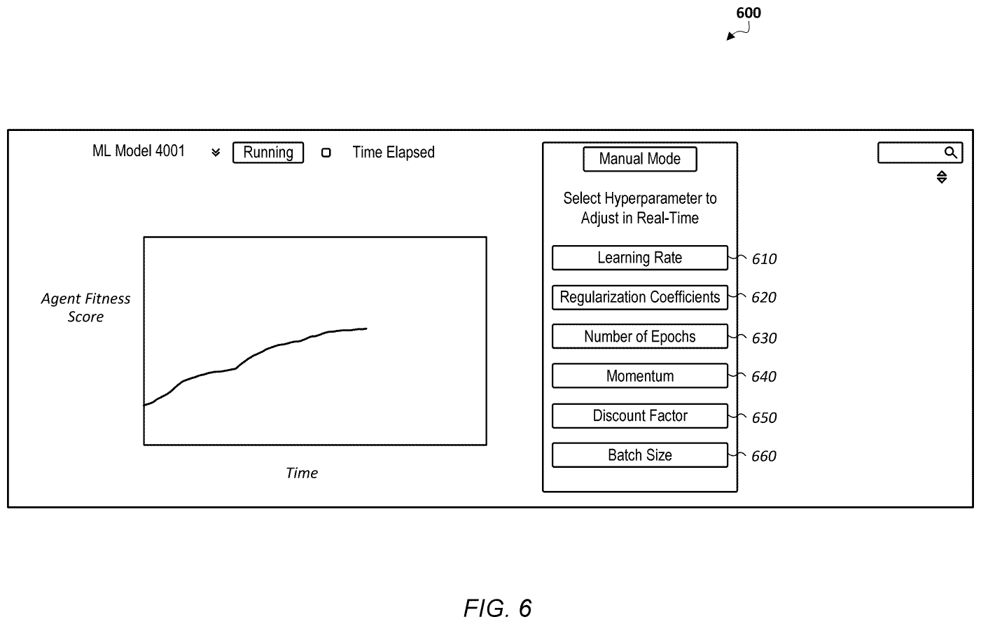

Turning now to FIG. 6, GUI 600 illustrates hyperparameters that may be adjusted by a user, in accordance with one or more embodiments of the current subject matter. In an example, the list of hyperparameters that may be adjusted by the user in manual mode may include learning rate 610, regularization coefficients 620, number of epochs 630, momentum 640, discount factor 650, and batch size 660. In other embodiments, the list of user-adjustable hyperparameters may include other types of hyperparameters.

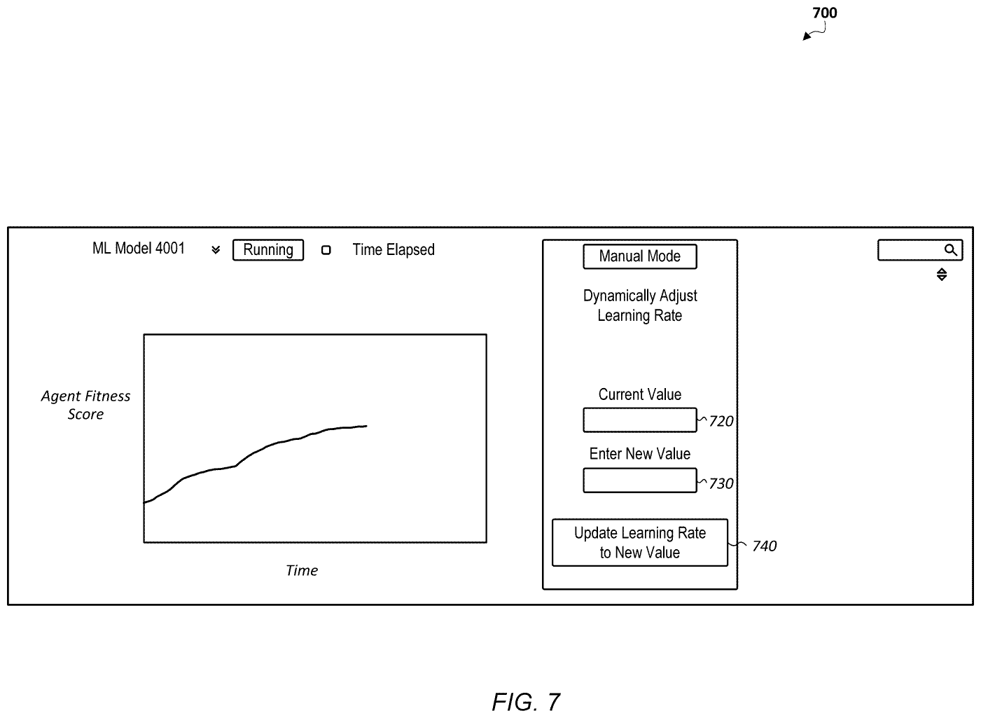

Referring now to FIG. 7, GUI 700 illustrates an example of a user interface for dynamically adjusting the learning rate, in accordance with one or more embodiments of the current subject matter. In an example, GUI 700 may be generated when the user clicks on the learning rate graphical element 610 as shown in GUI 600 (of FIG. 6). In GUI 700, the user may observe the current value of the learning rate in box 720, and the user may enter the desired new value of the learning rate in box 730. Then, the user may click on graphical element 740 to dynamically adjust the learning rate to the new value.

Still further, the GUI may present the user with the option of switching back and forth during the training run, from the previous set of hyperparameter adjustments to manual control and/or from manual control to a previous set of hyperparameter adjustments. The GUI may receive a user input indicating that one or more aspects of a recorded set of hyperparameter adjustments should be applied to a training run. These one or more aspects of the recorded set of hyperparameter adjustments may include learning rate adjustments and the timing of when the learning rate adjustment should occur, weight decay adjustments and the timing of when the weight decay adjustment should occur, and so on.

For example, the user may start out the training run by applying a previous set of hyperparameter adjustments to the machine learning model during an initial period of time, or an initial number of passes. Then, the user may wish to switch to manual control. Accordingly, the user may click on graphical element 510 of GUI 500 to enable manual control of hyperparameter adjustments. After the user switches to manual control, the user may dynamically adjust individual hyperparameters for some period of time or for some number of passes. Then, the user may select graphical element 520 to switch back to automatic mode. In automatic mode, the software will apply the previous set of hyperparameter adjustments to the machine learning model for the remainder of the training run. The software may link up the elapsed time of the training run to the timing of the hyperparameter adjustments that were recorded during the previous training run so as to synchronize the timing between the training run and the recorded values. This will ensure that the hyperparameter adjustments will be performed at the proper points in time as they were performed in the previously recorded training run.

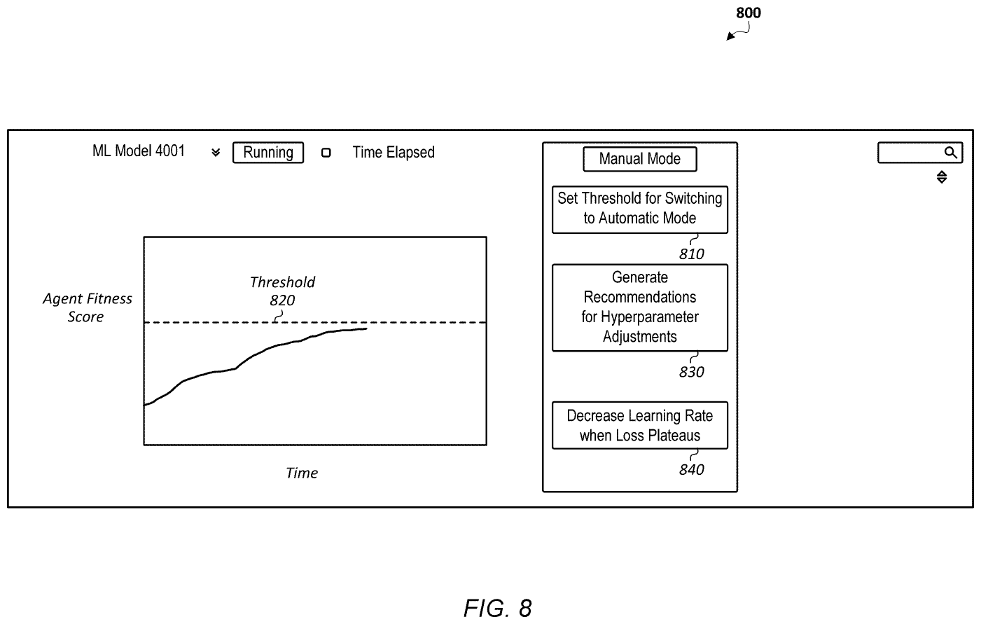

In an example, a GUI 800 (of FIG. 8) may include a graphical element 810 that when selected by a user, allows the user to set a threshold 820 for causing the hyperparameter turning engine to switch from manual mode to automatic mode. The user may move the threshold 820 to a desired location in the corresponding performance value graph of GUI 800. The hyperparameter turning engine may monitor a particular performance value, and when this performance value crosses threshold 820, the hyperparameter turning engine may switch from manual mode to automatic mode for tuning the hyperparameters. In the example of GUI 800, the performance value being monitored is the agent fitness score. In other embodiments, other types of performance values may be monitored. Additionally, GUI 800 may include a graphical element 830 which when selected by a user, causes the hyperparameter turning engine to generate recommendations for hyperparameter adjustments. Still further, GUI 800 may include a graphical element 840 which when selected by a user, causes the hyperparameter turning engine to reduce the learning rate when the loss plateaus. In other words, when the loss remains relatively flat for some number of passes, the learning rate may be decreased if the user clicks on graphical element 840. In other embodiments, GUI 800 may include other graphical elements that allow the user to customize the hyperparameter adjustments that are performed by the hyperparameter turning engine during a training run.

In an example, a system may store a plurality of hyperparameter adjustment recordings corresponding to a plurality of training runs. These training runs may be for a single type of machine learning model, or these training runs may be for a plurality of different types of machine learning models. Also, the system may store the performance values associated with each training run. The system may train a hyperparameter adjustment machine learning model to learn the appropriate times for making hyperparameter adjustments based on the previously recorded training runs and based on the performance values associated with these previous training runs. After training a hyperparameter adjustment machine learning model, the trained hyperparameter adjustment machine learning model may be used to make dynamic adjustments to hyperparameters to new, development-stage machine learning models being trained. It is noted that a trained hyperparameter adjustment machine learning model may also be referred to as a hyperparameter tuning engine.

Alternatively, a hybrid approach may be utilized, where the hyperparameter tuning engine monitors the performance values in real-time as a new development-stage machine learning model is being trained. In this hybrid approach, the hyperparameter tuning engine may generate recommendations for a user to make a specific hyperparameter adjustment. A user may select this option for the hyperparameter tuning engine to generate recommendations by clicking on graphical element 830. For example, after detecting performance value reaching a threshold in real-time, the trained hyperparameter adjustment machine learning model may generate a recommendation that the user reduce a learning rate. In response to viewing the recommendation in the GUI, the user may cause the recommended hyperparameter adjustment to be made to the particular hyperparameter by accepting the recommendation, such as by clicking in the appropriate location in GUI 800. The GUI may include an option to automatically apply recommendations. Alternatively, the GUI may generate a recommendation and indicate to the user that the recommended hyperparameter adjustment will be made unless the user intervenes and rejects the recommendation.

The GUI may include a switch, option, or graphical element for allowing the user to switch between manual mode and automatic mode for making hyperparameter adjustments. In some stages of the training, the user may wish to have direct control. In other stages, the user may relinquish control over dynamic hyperparameter adjustments to the trained model.

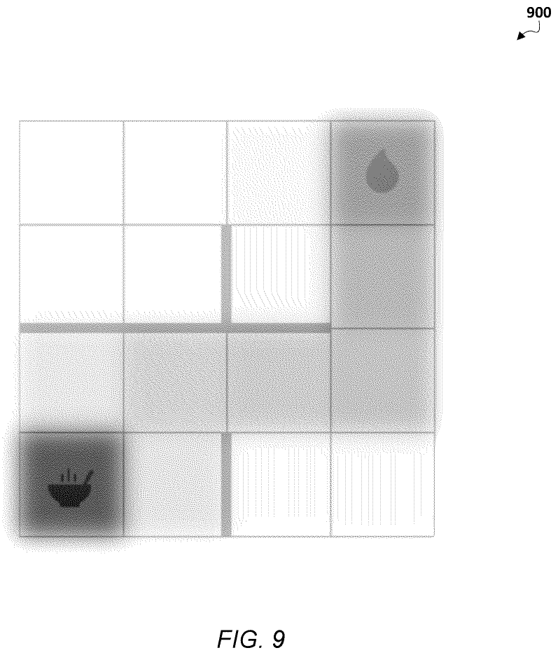

Referring now to FIG. 9, a plot 900 of dynamic reward shaping is shown, in accordance with one or more embodiments of the current subject matter. Reinforcement learning (RL) is a computational paradigm where a learner, called an agent, interacts with a dynamic environment to achieve certain goals by learning to make optimal decisions. The agent receives feedback in the form of rewards and modifies its strategy, termed as policy, to improve its performance over time. In the RL context, the interaction between the agent and the environment is modeled as a Markov Decision Process (MDP). An MDP provides a mathematical framework for modeling decision-making in situations where outcomes are partly random and partly under the control of a decision maker. The objective in RL is to learn a policy, a mapping from states to actions, that maximizes the expected cumulative reward. The cumulative reward is often discounted by a discount factor, which represents the difference in importance between future rewards and immediate rewards. Deep reinforcement learning extends these concepts by using deep neural networks to approximate the policy or the value functions associated with the states, which help in making decisions. This approach has been pivotal in solving complex decision-making tasks that require high-dimensional state and action spaces.

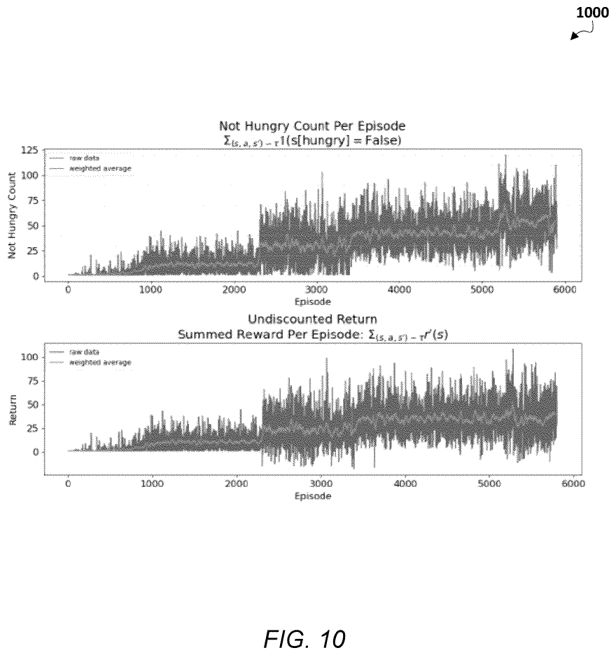

Tuning of hyperparameters such as the learning rate and the discount factor plays a critical role in the convergence and performance of RL algorithms. Prominent algorithms like Proximal Policy Optimization (PPO), Double Deep Q-Network (DDQN), and Advantage Actor-Critic (A2C) have shown different sensitivities to these parameters. Recent advancements have demonstrated the efficacy of adapting these hyperparameters dynamically in response to ongoing learning progress, which can significantly enhance learning efficiency and effectiveness in complex environments like the Hungry Thirsty Domain. LiveTune allows users to adjust hyperparameters and incorporate feedback to reduce the time to find an optimal policy without interrupting training. FIG. 9 and FIG. 10 demonstrate the effectiveness of dynamic reward shaping and hyperparameter tuning for teaching deep reinforcement learning agents.

Reinforcement learning strategies may be assessed through reward shaping within the Hungry Thirsty domain. This scenario involves a 4×4 grid, where obstacles block certain paths between adjacent blocks (see FIG. 9). In randomly assigned corners of the grid, food and water are placed. Following Booth et al., each episode is capped at 200 steps, using a modified environment to increase the challenge. The agent possesses a simple set of actions: moving in cardinal directions, eating, or drinking. Its primary objectives are to avoid hunger by consuming food and managing thirst, which is compulsory for eating. The agent is classified as not hungry if it has consumed food in the preceding step and can only consume food if not thirsty. To quench its thirst, the agent must be situated on a water tile. Post-drinking, the agent faces a 10% chance of becoming thirsty again in every consequent step, necessitating a return to water. The agent's state at any time includes its grid location and boolean indicators for hunger H and thirst T. Performance is evaluated by measuring the agent's fitness, defined as the number of steps spent not hungry. The agent's optimal policy directs it towards water when thirsty and towards food otherwise. The reward function structure is designed to encourage the agent to manage its states effectively. The challenge is to create a reward scheme that accurately reflects the objective of minimizing hunger, a nontrivial task in reinforcement learning. Booth et al. demonstrate that suboptimal reward structures often result from incorrect assumptions about the spatial relationship between food and water.

Experiment participants may utilize a heatmap of the most frequent states by the agent (see FIG. 9) to dynamically adjust rewards to optimize fitness. LiveTune enables continuous, real-time monitoring and adjustment of parameters in training environments such as the Hungry Thirsty domain. This system allows for immediate and ongoing optimizations without the need to pause or restart the training process, thereby enhancing learning efficiency and adaptiveness.

When aiming to train the most effective RL agent, users may incorporate LiveTune for dynamic adjustment of reward functions and algorithm parameters. When running the experiment, LiveTune may generate a web user interface for users to interact with the program. The baseline users may have access to a live plot 1000 (of FIG. 10) of the fitness of their agent and a heat map 900 (of FIG. 9) of how the agent is moving inside the gridworld. Using feedback from the algorithm, the users can change the reward function structure and hyperparameters of the algorithm.

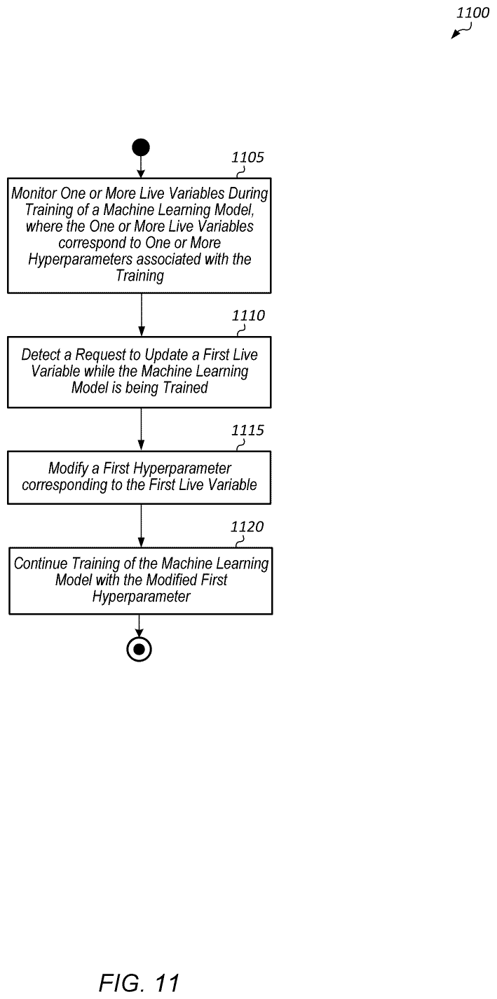

Referring now to FIG. 11, a process is depicted for performing dynamic hyperparameter turning during machine learning model training, in accordance with one or more embodiments of the current subject matter. A hyperparameter tuning engine monitors one or more live variables during training of a machine learning model, where the one or more live variables correspond to one or more hyperparameters associated with the training of the machine learning model (block 1105). Next, while monitoring the one or more live variables, the hyperparameter tuning engine detects a request to update a first live variable while the machine learning model is being trained (block 1110). In response to detecting the request, the hyperparameter tuning engine modifies a first hyperparameter corresponding to the first live variable (block 1115). It is noted that the first hyperparameter is modified without restarting a training process associated with the machine learning model. Then, a training engine continues training of the machine learning model with the modified first hyperparameter (block 1120). After block 1120, method 1100 may end. It is noted that a new iteration of method 1100 may be initiated after block 1120 so that the live variables may continue to be monitored during training of the machine learning model.

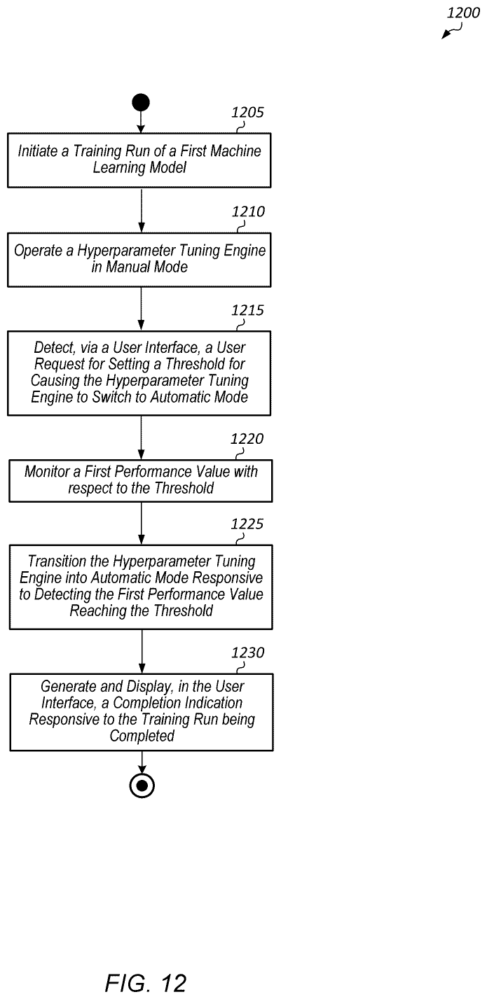

Turning now to FIG. 12, a process is depicted for a hyperparameter tuning engine transitioning between manual and automatic mode, in accordance with one or more embodiments of the current subject matter. At the beginning of method 1200, a training run of a first machine learning model is initiated by a host software application (e.g., application 165 of FIG. 1) (block 1205). After the training run is initiated, a hyperparameter tuning engine is operated in manual mode (block 1210). In manual mode, a user is able to dynamically adjust hyperparameters without stopping the training run of the first machine learning model.

Next, a user request is detected via a user interface, where the user request involves setting a threshold for causing the hyperparameter tuning engine to switch to automatic mode (block 1215). In automatic mode, the hyperparameter tuning engine dynamically adjusts hyperparameters without user intervention and without stopping the training run of the first machine learning model. Then, the hyperparameter tuning engine monitors a first performance value with respect to the threshold (block 1220). In an example, the first performance value is an agent fitness score. In another example, the first performance value is a loss function value. In a further example, the first performance value is a gradient flow value. In other examples, the first performance value is any of various other types of values and/or parameters.

Next, the hyperparameter tuning engine transitions into automatic mode responsive to detecting the first performance value reaching the threshold (block 1225). Then, the host application generates and displays, in the user interface, a completion indication responsive to the training run being completed (block 1230). After block 1230, method 1200 may end.

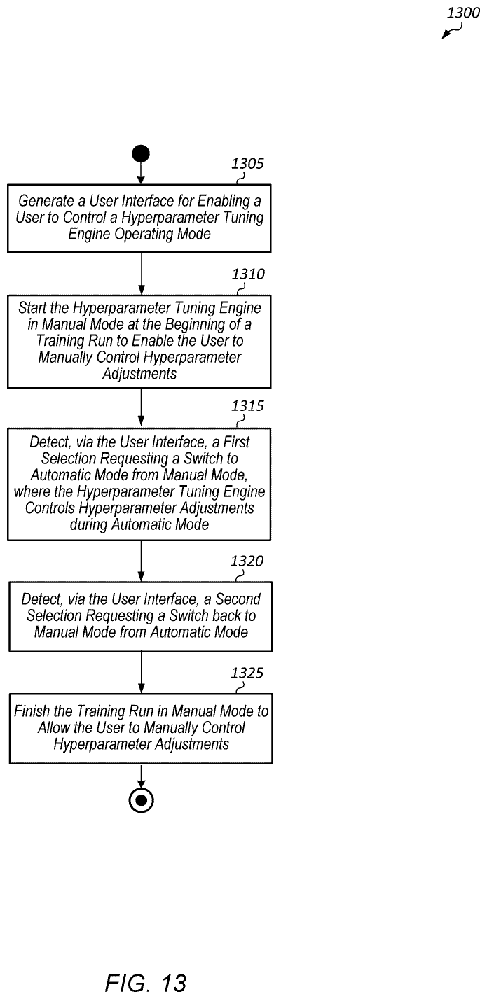

Referring now to FIG. 13, a process for generating a user interface for enabling a user to control a hyperparameter tuning engine operating mode is depicted, in accordance with one or more embodiments of the current subject matter. A user interface is generated for enabling a user to control a hyperparameter tuning engine operating mode (block 1305). The hyperparameter turning engine starts in manual mode at the beginning of a training run to enable the user to manually control hyperparameter adjustments (block 1310). In another embodiment, the hyperparameter turning engine may start in automatic mode at the beginning of a training run to allow the hyperparameter turning engine to handle hyperparameter adjustments without user intervention.

Next, a first selection is detected via the user interface, where the first selection requests a switch to automatic mode from manual mode, and where the hyperparameter turning engine controls hyperparameter adjustments during automatic mode (block 1315). Then, at a later point in time, a second selection is detected, where the second selection requests a switch back to manual mode from automatic mode (block 1320). The training run is finished in manual mode to allow the user to manually control hyperparameter adjustments (block 1325). After block 1325, method 1300 ends. It should be understood that the example of switching from manual to automatic to manual mode is merely indicative of one particular embodiment. It is noted that during the training run, the user may switch back and forth between manual and automatic mode any number of times, with the number varying from embodiment to embodiment.

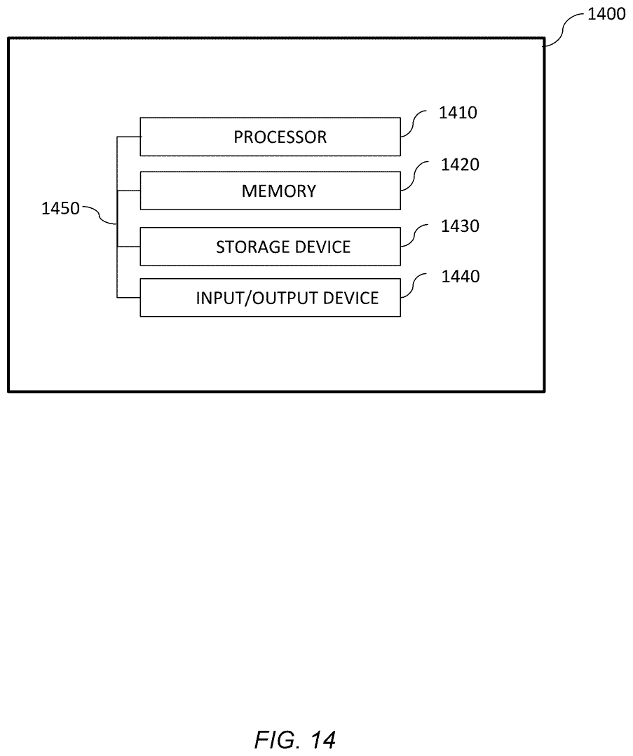

In some implementations, the current subject matter may be configured to be implemented in a system 1400, as shown in FIG. 14. For example, the operations of LiveTune (or one or more if not all of the aspects of LiveTune) may be at least in part physically comprised on system 1400. To illustrate further system 1400 may include an operating system, a hypervisor, and/or other resources, to provide virtualized physical resources (e.g., via virtual machines). The system 1400 may include a processor 1410, a memory 1420, a storage device 1430, and an input/output device 1440. Each of the components 1410, 1420, 1430 and 1440 may be interconnected using a system bus 1450. The processor 1410 may be configured to process instructions for execution within the system 1400. In some implementations, the processor 1410 may be a single-threaded processor. In alternate implementations, the processor 1410 may be a multi-threaded processor. The processor 1410 may be further configured to process instructions stored in the memory 1420 or on the storage device 1430, including receiving or sending information through the input/output device 1440. The memory 1420 may store information within the system 1400. In some implementations, the memory 1420 may be a computer-readable medium. In alternate implementations, the memory 1420 may be a volatile memory unit. In yet some implementations, the memory 1420 may be a non-volatile memory unit. The storage device 1430 may be capable of providing mass storage for the system 1400. In some implementations, the storage device 1430 may be a computer-readable medium. In alternate implementations, the storage device 1430 may be a floppy disk device, a hard disk device, an optical disk device, a tape device, non-volatile solid state memory, or any other type of storage device. The input/output device 1440 may be configured to provide input/output operations for the system 1400. In some implementations, the input/output device 1440 may include a keyboard and/or pointing device. In alternate implementations, the input/output device 1440 may include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, articles, and/or articles of manufacture depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system comprising: at least one processor; at least one memory storing instructions that, when executed by the at least one processor, cause operations comprising: monitoring one or more program variables during training of an untrained version of a machine learning model, wherein the one or more program variables correspond to one or more hyperparameters associated with the training; detecting a request to update a first program variable while the untrained version of the machine learning model is being trained; modifying a first hyperparameter corresponding to the first program variable; continuing training of the machine learning model with the modified first hyperparameter; and generating a trained version of the machine learning model responsive to completing the training of untrained version of the machine learning model.

Example 2: The system of Example 1, wherein the operations further comprising performing, with the trained version of the machine learning model, one or more actions.

Example 3: The system of any of Examples 1-2, wherein the one or more actions comprises processing a first dataset to generate a first classification result.

Example 4: The system of any of Examples 1-3, wherein the operations further comprise embedding one or more Boolean flags in the untrained version of the machine learning model, wherein the one or more Boolean flags enable procedures to be activated or halted based on real-time commands without terminating the training of the untrained version of the machine learning model.

Example 5: The system of any of Examples 1-4, wherein the operations further comprise enabling multiple simultaneous users to collaborate in parallel to modify multiple hyperparameters during training of the untrained version of the machine learning model.

Example 6: The system of any of Examples 1-5, wherein the first hyperparameter is modified without restarting a training process associated with the machine learning model.

Example 7: The system of any of Examples 1-6, wherein the one or more program variables are monitored via one or more ports on a first device.

Example 8: The system of any of Examples 1-7, wherein the operations further comprise: generating, in a user interface, a first graphical element that when selected, places a hyperparameter tuning engine in a manual mode to enable a user to make adjustments to the one or more hyperparameters; generating, in the user interface, a second graphical element that when selected, places the hyperparameter tuning engine in an automatic mode to enable the hyperparameter tuning engine to automatically make adjustments to the one or more hyperparameters based on one or more performance values; and generating, in the user interface, a third graphical element that when selected, causes the hyperparameter tuning engine to switch from manual to automatic mode when a first performance value reaches a threshold.

Example 9: The system of any of Examples 1-8, wherein the first performance value is an agent fitness score.

Example 10: The system of any of Examples 1-9, wherein the operations further comprise generating, in a user interface, indications of stored hyperparameter adjustment values from one or more previous training runs.

Example 11: The system of any of Examples 1-10, wherein the operations further comprise generating, in the user interface, a graphical element that when selected, causes a first set of hyperparameter adjustment values from a first previous training run to be applied to a new training run of the machine learning model.

Example 12: The system of any of Examples 1-11, wherein the operations further comprise generating, in a user interface, a graphical element that when selected, causes the hyperparameter tuning engine to generate recommendations for hyperparameter adjustments based on one or more performance values.

Example 13: A method comprising: monitoring one or more program variables during training of an untrained version of a machine learning model, wherein the one or more program variables correspond to one or more hyperparameters associated with the training; detecting a request to update a first program variable while the untrained version of the machine learning model is being trained; modifying a first hyperparameter corresponding to the first program variable; continuing training of the machine learning model with the modified first hyperparameter; and generating a trained version of the machine learning model responsive to completing the training of untrained version of the machine learning model.

Example 14: The method of Example 13, further comprising performing, with the trained version of the machine learning model, one or more actions.

Example 15: The method of any of Examples 13-14, wherein the one or more actions comprises processing a first dataset to generate a first classification result.

Example 16: The method of any of Examples 13-15, further comprising embedding one or more Boolean flags in the untrained version of the machine learning model, wherein the one or more Boolean flags enable procedures to be activated or halted based on real-time commands without terminating the training of the untrained version of the machine learning model.

Example 17: The method of any of Examples 13-16, further comprising enabling multiple simultaneous users to collaborate in parallel to modify multiple hyperparameters during training of the untrained version of the machine learning model.

Example 18: The method of any of Examples 13-17, further comprising: generating, in a user interface, a first graphical element that when selected, places a hyperparameter tuning engine in a manual mode to enable a user to make adjustments to the one or more hyperparameters; generating, in the user interface, a second graphical element that when selected, places the hyperparameter tuning engine in an automatic mode to enable the hyperparameter tuning engine to automatically make adjustments to the one or more hyperparameters based on one or more performance values; and generating, in the user interface, a third graphical element that when selected, causes the hyperparameter tuning engine to switch from manual to automatic mode when a first performance value reaches a threshold.

Example 19: The method of any of Examples 13-18, further comprising generating, in a user interface, a graphical element that when selected, causes the hyperparameter tuning engine to generate recommendations for hyperparameter adjustments based on one or more performance values.

Example 20: A non-transitory computer readable medium storing instructions, which when executed by at least one data processor, result in operations comprising: monitoring one or more program variables during training of an untrained version of a machine learning model, wherein the one or more program variables correspond to one or more hyperparameters associated with the training; detecting a request to update a first program variable while the untrained version of the machine learning model is being trained; modifying a first hyperparameter corresponding to the first program variable; continuing training of the machine learning model with the modified first hyperparameter; and generating a trained version of the machine learning model responsive to completing the training of untrained version of the machine learning model.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor;
at least one memory storing instructions that, when executed by the at least one processor, cause operations comprising:
monitoring one or more program variables during training of an untrained version of a machine learning model, wherein the one or more program variables correspond to one or more hyperparameters associated with the training;
detecting a request to update a first program variable while the untrained version of the machine learning model is being trained;
modifying a first hyperparameter corresponding to the first program variable;
continuing training of the machine learning model with the modified first hyperparameter; and
generating a trained version of the machine learning model responsive to completing the training of the untrained version of the machine learning model.

2. The system of claim 1, wherein the operations further comprising performing, with the trained version of the machine learning model, one or more actions.

3. The system of claim 2, wherein the one or more actions comprises processing a first dataset to generate a first classification result.

4. The system of claim 1, wherein the operations further comprise embedding one or more Boolean flags in the untrained version of the machine learning model, wherein the one or more Boolean flags enable procedures to be activated or halted based on real-time commands without terminating the training of the untrained version of the machine learning model.

5. The system of claim 1, wherein the operations further comprise enabling multiple simultaneous users to collaborate in parallel to modify multiple hyperparameters during training of the untrained version of the machine learning model.

6. The system of claim 1, wherein the first hyperparameter is modified without restarting a training process associated with the machine learning model.

7. The system of claim 1, wherein the one or more program variables are monitored via one or more ports on a first device.

8. The system of claim 1, wherein the operations further comprise:
generating, in a user interface, a first graphical element that when selected, places a hyperparameter tuning engine in a manual mode to enable a user to make adjustments to the one or more hyperparameters;
generating, in the user interface, a second graphical element that when selected, places the hyperparameter tuning engine in an automatic mode to enable the hyperparameter tuning engine to automatically make adjustments to the one or more hyperparameters based on one or more performance values; and
generating, in the user interface, a third graphical element that when selected, causes the hyperparameter tuning engine to switch from manual to automatic mode when a first performance value reaches a threshold.

9. The system of claim 8, wherein the first performance value is an agent fitness score.

10. The system of claim 1, wherein the operations further comprise generating, in a user interface, indications of stored hyperparameter adjustment values from one or more previous training runs.

11. The system of claim 10, wherein the operations further comprise generating, in the user interface, a graphical element that when selected, causes a first set of hyperparameter adjustment values from a first previous training run to be applied to a new training run of the machine learning model.

12. The system of claim 1, wherein the operations further comprise generating, in a user interface, a graphical element that when selected, causes the hyperparameter tuning engine to generate recommendations for hyperparameter adjustments based on one or more performance values.

13. A method comprising:
monitoring one or more program variables during training of an untrained version of a machine learning model, wherein the one or more program variables correspond to one or more hyperparameters associated with the training;
detecting a request to update a first program variable while the untrained version of the machine learning model is being trained;
modifying a first hyperparameter corresponding to the first program variable;
continuing training of the machine learning model with the modified first hyperparameter; and
generating a trained version of the machine learning model responsive to completing the training of the untrained version of the machine learning model.

14. The method of claim 13, further comprising performing, with the trained version of the machine learning model, one or more actions.

15. The method of claim 14, wherein the one or more actions comprises processing a first dataset to generate a first classification result.

16. The method of claim 13, further comprising embedding one or more Boolean flags in the untrained version of the machine learning model, wherein the one or more Boolean flags enable procedures to be activated or halted based on real-time commands without terminating the training of the untrained version of the machine learning model.

17. The method of claim 13, further comprising enabling multiple simultaneous users to collaborate in parallel to modify multiple hyperparameters during training of the untrained version of the machine learning model.

18. The method of claim 13, further comprising:
generating, in a user interface, a first graphical element that when selected, places a hyperparameter tuning engine in a manual mode to enable a user to make adjustments to the one or more hyperparameters;
generating, in the user interface, a second graphical element that when selected, places the hyperparameter tuning engine in an automatic mode to enable the hyperparameter tuning engine to automatically make adjustments to the one or more hyperparameters based on one or more performance values; and
generating, in the user interface, a third graphical element that when selected, causes the hyperparameter tuning engine to switch from manual to automatic mode when a first performance value reaches a threshold.

19. The method of claim 13, further comprising generating, in a user interface, a graphical element that when selected, causes the hyperparameter tuning engine to generate recommendations for hyperparameter adjustments based on one or more performance values.

20. A non-transitory computer readable medium storing instructions, which when executed by at least one data processor, result in operations comprising:
monitoring one or more program variables during training of an untrained version of a machine learning model, wherein the one or more program variables correspond to one or more hyperparameters associated with the training;
detecting a request to update a first program variable while the untrained version of the machine learning model is being trained;
modifying a first hyperparameter corresponding to the first program variable;
continuing training of the machine learning model with the modified first hyperparameter; and
generating a trained version of the machine learning model responsive to completing the training of the untrained version of the machine learning model.
